(19) United States
(12) Patent Application Publication
(10) Pub. No.: US 2010/0149393 A1
(43) Pub. Date: Jun. 17, 2010

(54) INCREASING THE RESOLUTION OF COLOR SUB-PIXEL ARRAYS

(75) Inventors: Jeffrey Jon Zarnowski, McGraw, NY (US); Ketan Vrajlal Karia, Cortland, NY (US); Thomas Poonnen, Cortland, NY (US); Michael Eugene Joyner, McGraw, NY (US); Li Liu, Tianjin (CN)

Correspondence Address: MORRISON & FOERSTER, LLP, 555 WEST FIFTH STREET, SUITE 3500, LOS ANGELES, CA, 90013-1024, US

(73) Assignee: Panavision Imaging, LLC, Homer, NY (US)

(21) Appl. No.: 12/712,146

(22) Filed: Feb. 24, 2010

Related U.S. Application Data
(63) Continuation-in-part of application No. 12/125,466, filed on May 22, 2008.

(51) Int. Cl. H04N 5/335

(52) U.S. Cl. 348/302; 348/E05.091

(57) ABSTRACT

Increasing the resolution of digital imagers is disclosed by sampling an image using diagonally oriented color sub-pixel arrays, and creating missing pixels from the sampled image data. A first method maps the diagonal color imager pixels to every other orthogonal display pixel. The missing display pixels can be computed by interpolating data from adjacent color imager pixels, and averaging color information from neighboring display pixels. This averaging can be done either by weighting the surrounding pixels equally, or by applying weights to the surrounding pixels based on intensity information. A second method utilizes the captured color imager sub-pixel data instead of interpolation. Missing color pixels for orthogonal displays can be obtained directly from the sub-pixel arrays formed between the row color pixels in the imager.

### CROSS-REFERENCE TO RELATED APPLICATIONS

This is a continuation-in-part (CIP) of U.S. application Ser. No. 12/125,466, filed on May 22, 2008, the contents of which are incorporated by reference herein in their entirety for all purposes.

### FIELD OF THE INVENTION

Embodiments of the invention relate to digital color image sensors, and more particularly, to enhancing the sensitivity and dynamic range of image sensors that utilize arrays of sub-pixels to generate the data for color pixels in a display, and optionally increase the resolution of color sub-pixel arrays.

### BACKGROUND OF THE INVENTION

Digital image capture devices are becoming ubiquitous in today's society. High-definition video cameras for the motion picture industry, image scanners, professional still photography cameras, consumer-level “point-and-shoot” cameras and hand-held personal devices such as mobile telephones are just a few examples of modern devices that commonly utilize digital color image sensors to capture images. Regardless of the image capture device, in most instances the most desirable images are produced when the sensors in those devices can capture fine details in both the bright and dark areas of a scene or image to be captured. In other words, the quality of the captured image is often a function of the amount of detail at various light levels that can be captured. For example, a sensor capable of generating an image with fine detail in both the bright and dark areas of the scene is generally considered superior to a sensor that captures fine detail in either bright or dark areas, but not both simultaneously. Sensors with an increased ability to capture both bright and dark areas in a single image are considered to have better dynamic range.

Thus, higher dynamic range becomes an important concern for digital imaging performance. For sensors with a linear response, their dynamic range can be defined as the ratio of their output's saturation level to the noise floor at dark. This definition is not suitable for sensors without a linear response. For all image sensors with or without linear response, the dynamic range can be measured by the ratio of the maximum detectable light level to the minimum detectable light level. Prior dynamic range extension methods fall into two general categories: improvement of sensor structure, a revision of the capturing procedure, or a combination of the two.

Structure approaches can be implemented at the pixel level or at the sensor array level. For example, U.S. Pat. No. 7,259,412 introduces a HDR transistor in a pixel cell. A revised sensor array with additional high voltage supply and voltage level shifter circuits is proposed in U.S. Pat. No. 6,861,635. The typical method for the second category is to use different exposures over multiple frames (e.g. long and short exposures in two different frames to capture both dark and bright areas of the image), and then combine the results from the two frames. The details are described in U.S. Pat. No. 7,133,069 and U.S. Pat. No. 7,190,402. In U.S. Pat. No. 7,202,463 and U.S. Pat. No. 6,018,365, different approaches with a combination of two categories are introduced. U.S. Pat. No. 7,518,646 discloses a solid state imager capable of converting analog pixel values to digital form on an arrayed per-column basis. U.S. Pat. No. 5,949,483 discloses an imaging device formed as a monolithic complementary metal oxide semiconductor integrated circuit including a focal plane array of pixel cells. U.S. Pat. No. 6,084,229 discloses a CMOS imager including a photosensitive device having a sense node coupled to a FET located adjacent to a photosensitive region, with another FET forming a differential input pair of an operational amplifier is located outside of the array of pixels.

In addition to increased dynamic range, increased pixel resolution is also an important concern for digital imaging performance. Conventional color digital imagers typically have a horizontal/vertical orientation, with each color pixel formed from one red (R) pixel, two green (G) pixels, and one blue (B) pixel in a 2×2 array (a Bayer pattern). The R and B pixels can be sub-sampled and interpolated to increase the effective resolution of the imager. Bayer pattern image processing is described in U.S. patent application Ser. No. 12/126,347, filed on May 23, 2008, the contents of which are incorporated by reference herein in their entirety for all purposes.

Although Bayer pattern interpolation results in increased imager resolution, the Bayer pattern subsampling used today generally does not produce sufficiently high quality color images.

### SUMMARY OF THE INVENTION

Embodiments of the invention improve the dynamic range of captured images by using sub-pixel arrays to capture light at different exposures and generate color pixel outputs for an image in a single frame. The sub-pixel arrays utilize supersampling and are generally directed towards high-end, high resolution sensors and cameras. Each sub-pixel array can include multiple sub-pixels. The sub-pixels that make up a sub-pixel array can include red (R) sub-pixels, green (G) sub-pixels, blue (B) sub-pixels, and in some embodiments, clear (C) sub-pixels. Because clear (a.k.a. monochrome or panachromatic) sub-pixels capture more light than color pixels, the use of clear sub-pixels can enable the sub-pixel arrays to capture a wider range of photon generated charge in a single frame during a single exposure period. Those sub-pixel arrays having clear sub-pixels effectively have a higher exposure level and can capture low-light scenes (for dark areas) better than those sub-pixel arrays without clear sub-pixels. Each sub-pixel array can produce a color pixel output that is a combination of the outputs of the sub-pixels in the sub-pixel array. The sub-pixel array can be oriented diagonally to improve visual resolution and color purity by minimizing color crosstalk. Each sub-pixel in a sub-pixel array can have the same exposure time, or in some embodiments, individual sub-pixels within a sub-pixel array can have different exposure times to improve the overall dynamic range even more.

One exemplary 3×3 sub-pixel array forming a color pixel in a diagonal strip pattern includes multiple R, G and B sub-pixels, each color arranged in a channel. One pixel can include the three sub-pixels of the same color. Diagonal color strip filters are described in U.S. Pat. No. 7,045,758. Another exemplary diagonal 3×3 sub-pixel array includes one or more clear sub-pixels. Clear pixels have been interspaced with color pixels as taught in U.S. Published Patent Application No. 20070024934. To enhance the sensitivity (dynamic range) of the sub-pixel array, one or more of the color sub-pixels can be replaced with clear sub-pixels. Sub-pixel arrays with more than three clear sub-pixels can also be used, although the color performance of the sub-pixel array can be diminished as a higher percentage of clear sub-pixels are used in the array. With more clear sub-pixels, the dynamic range of the sub-pixel array can go up because more light can be detected, but less color information can be obtained. Using fewer clear sub-pixels, the dynamic range will be smaller, but more color information can be obtained. A clear sub-pixel can be as much as six times more sensitive as compared to other colored sub-pixels (i.e. a clear sub-pixel will produce up to six times greater photon generated charge than a colored sub-pixel, given the same amount of light). Thus, a clear sub-pixel captures dark images well, but will get overexposed (saturated) at a smaller exposure time than color sub-pixels given the same exposure.

Each sub-pixel array can produce a color pixel output that is a combination of the outputs of the sub-pixels in the sub-pixel array. In some embodiments of the invention, all sub-pixels can have the same exposure time, and all sub-pixel outputs can be normalized to the same range (e.g. between [0,1]). The final color pixel output can be the combination of all sub-pixels (each sub-pixel type having different gains or response curves). However, if a higher dynamic range is desired, the exposure time of individual sub-pixels can be varied (e.g. the clear sub-pixel in a sub-pixel array can be exposed for a longer time, while the color sub-pixels can be exposed for a shorter time). In this manner, even darker areas can be captured, while the regular color sub-pixels exposed for a shorter time can capture even brighter areas. Alternately, a portion of the clear sub-pixels may have short exposure and a portion can have a long exposure to capture the very dark and very bright portions of the image. Alternately, the color pixels can have the same or similar distribution of short and long exposure on the sub-pixels to extend the dynamic range within a captured image. The types of pixels used can be Charge Coupled Devices (CCDs), Charge Injection Devices (CIDs), CMOS Active Pixel Sensors (APSs) or CMOS Active Column Sensors (ACSs) or passive photo-diode pixels with either rolling shutter or global shutter implementations.

Embodiments of the invention also increase the resolution of imagers by sampling an image using diagonally oriented color sub-pixel arrays, and creating additional pixels from the sampled image data to form a complete image in an orthogonal display. Although diagonal embodiments are presented herein, other pixel layouts on an orthogonal grid can be utilized as well.

A first method maps the diagonal color imager pixels to every other orthogonal display pixel. The missing display pixels can be computed by interpolating data from adjacent color imager pixels. For example, a missing display pixel can be computed by averaging color information from neighboring display pixels to the left and right and/or top and bottom, or from all four neighboring pixels. This averaging can be done either by weighting the surrounding pixels equally, or by applying weights to the surrounding pixels based on intensity information. By performing this interpolation, the resolution in the horizontal direction can be effectively increased by a root two of the original number of pixels and the interpolated pixel count doubles the number of displayed pixels.

A second method utilizes the captured color imager sub-pixel data instead of interpolation. Missing color pixels for orthogonal displays can simply be obtained from the sub-pixel arrays formed between the row color pixels in the imager. To accomplish this, one method is to store all sub-pixel information in memory when each row of color pixels is read out. This way, missing pixels can be re-created by the processor using the stored data. Another method stores and reads out both the color pixels and the missing pixels computed as described above. In some embodiments, binning may also be employed.

### BRIEF DESCRIPTION OF THE DRAWINGS

FIG. 1 illustrates an exemplary 3×3 sub-pixel array forming a color pixel in a diagonal strip pattern according to embodiments of the invention.

FIGS. 2a, 2b and 2c illustrate exemplary diagonal 3×3 sub-pixel arrays, each sub-pixel array containing one, two and three clear sub-pixels, respectively, according to embodiments of the invention.

FIG. 3a illustrates an exemplary digital image sensor portion having four repeating sub-pixel array designs designated 1, 2, 3 and 4, each sub-pixel array design having a clear pixel in a different location according to embodiments of the invention.

FIG. 3b illustrates the exemplary sensor portion of FIG. 3a in greater detail, showing the four sub-pixel array designs 1, 2, 3 and 4 as 3×3 sub-pixel arrays of R, G, B sub-pixels and one clear sub-pixel in a different location for every design.

FIG. 4 illustrates an exemplary image capture device including a sensor formed from multiple sub-pixel arrays according to embodiments of the invention.

FIG. 5 illustrates a hardware block diagram of an exemplary image processor that can be used with a sensor formed from multiple sub-pixel arrays according to embodiments of the invention.

FIG. 6a illustrates an exemplary color imager pixel array in an exemplary color imager.

FIG. 6b illustrates an exemplary orthogonal color display pixel array in an exemplary display device.

FIG. 7a illustrates an exemplary color imager for which a first method for compensating for this compression can be applied according to embodiments of the invention.

FIG. 7b illustrates an exemplary orthogonal display pixel array for which interpolation can be applied in a display chip according to embodiments of the invention.

FIG. 8 illustrates an exemplary binning circuit in an imager chip for a single column of sub-pixels of the same color according to embodiments of the invention.

FIG. 9a illustrates a portion of an exemplary diagonal color imager and an exemplary second method for compensating for the horizontal compression of display pixels according to embodiments of the invention.

FIG. 9b illustrates a portion of an exemplary orthogonal display pixel array according to embodiments of the invention.

FIG. 10 illustrates an exemplary readout circuit in a display chip for a single column of imager sub-pixels of the same color according to embodiments of the invention.

FIG. 11 illustrates a portion of a digital imager presented for explaining embodiments in which additional capture circuits are used in each column according to embodiments of the invention.

FIG. 12 illustrates an exemplary readout circuit according to embodiments of the present invention.

FIG. 13 is a table showing the exemplary capture and readout of imager sub-pixel data for the column of FIG. 11 according to embodiments of the invention.

FIG. 14 is a table showing the exemplary capture and readout of sub-pixel data for column of FIG. 11 according to embodiments of the invention.

FIG. 15 illustrates an exemplary digital color imager comprised of diagonal 4×4 sub-pixel arrays according to embodiments of the invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

Embodiments of the invention can improve the dynamic range of captured images by using sub-pixel arrays to capture light at different exposures and generate color pixel outputs for an image in a single frame. The sub-pixel array described herein utilizes supersampling and is directed towards high-end, high resolution sensors and cameras. Each sub-pixel array can include multiple sub-pixels. The sub-pixels that make up a sub-pixel array can include red (R) sub-pixels, green (G) sub-pixels, blue (B) sub-pixels, and in some embodiments, clear sub-pixels. Each color sub-pixel can be covered with a micro-lens to increase the fill factors. A clear sub-pixel is a sub-pixel with no color filter covering. Because clear sub-pixels capture more light than color pixels, the use of clear sub-pixels can enable the sub-pixel arrays to capture different exposures in a single frame with the same exposure period for all pixels in the array. Those sub-pixel arrays having clear sub-pixels effectively have a higher exposure level and can capture low-light scenes (for dark areas) better than those sub-pixel arrays without clear sub-pixels. Each sub-pixel array can produce a color pixel output that is a combination of the outputs of the sub-pixels in the sub-pixel array. The sub-pixel array can be oriented diagonally to improve visual resolution and color purity by minimizing color crosstalk. Each sub-pixel in a sub-pixel array can have the same exposure time, or in some embodiments, individual sub-pixels within a sub-pixel array can have different exposure times to improve the overall dynamic range even more. With embodiments of the invention, the dynamic range can be improved without significant structure changes and processing costs.

Embodiments of the invention also increase the resolution of imagers by sampling an image using diagonally oriented color sub-pixel arrays, and creating additional pixels from the sampled image data to form a complete image in an orthogonal display. A first method maps the diagonal color imager pixels to every other orthogonal display pixel. The missing display pixels can be computed by interpolating data from adjacent color imager pixels. For example, a missing display pixel can be computed by averaging color information from neighboring display pixels to the left and right and/or top and bottom, or from all four neighboring pixels. A second method utilizes the captured color imager sub-pixel data instead of interpolation. Missing color pixels for orthogonal displays can simply be obtained from the sub-pixel arrays formed between the row color pixels in the imager. The second method maximizes the resolution up to the resulting color image to that of the color sub-pixel array without mathematical interpolation to enhance the resolution. Of course, interpolation can then be utilized to further enhance resolution if the application requires it. Sub-pixel image arrays with variable resolution facilitate the use of anamorphic lenses by maximizing the resolution of the imager. Anamorphic lenses squeeze the image aspect ratio to fit a given format film or solid state imager for image capture, usually along the horizontal axis. The sub-pixel imager of the present invention can be read out to un-squeeze the captured image and restore it to the original aspect ratio of the scene.

Although the sub-pixel arrays according to embodiments of the invention may be described and illustrated herein primarily in terms of high-end, high resolution imagers and cameras, it should be understood that any type of image capture device for which an enhanced dynamic range and resolution is desired can utilize the sensor embodiments and missing display pixel generation methodologies described herein. Furthermore, although the sub-pixel arrays may be described and illustrated herein in terms of 3×3 arrays of sub-pixels forming strip pixels with sub-pixels having circular sensitive regions, other array sizes and shapes of pixels and sub-pixels can be utilized as well. In addition, although the color sub-pixels in the sub-pixel arrays may be described as containing R, G and B sub-pixels, in other embodiments colors other than R, G, and B can be used, such as the complementary colors cyan, magenta, and yellow, and even different color shades (e.g. two different shades of blue) can be used. It should also be understood that these colors may be described generally as first, second and third colors, with the understanding that these descriptions do not imply a particular order.

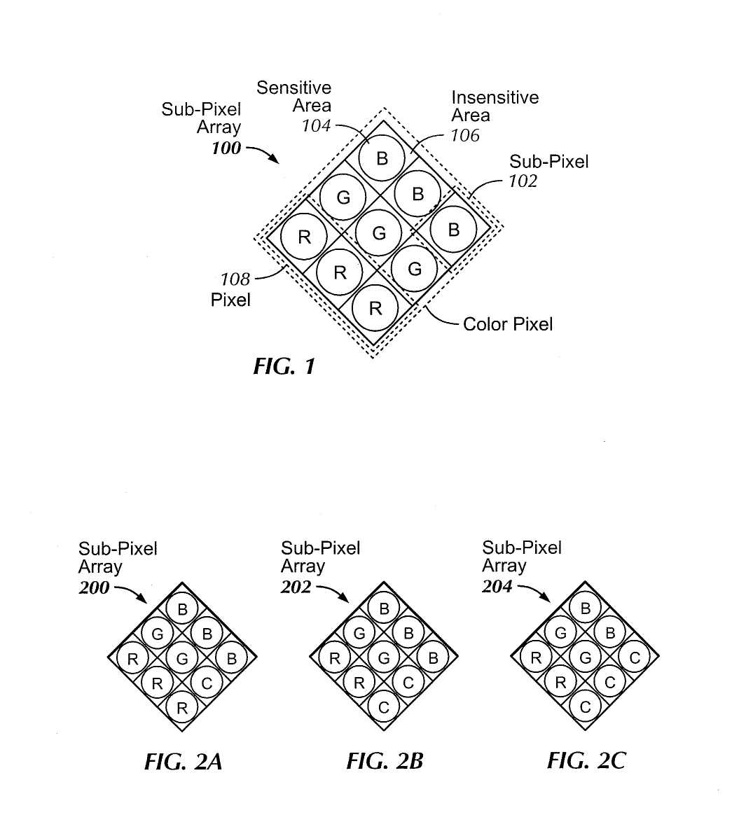

Improving dynamic range. FIG. 1 illustrates an exemplary 3×3 sub-pixel array 100 forming a color pixel in a diagonal strip pattern according to embodiments of the invention. Sub-pixel array 100 can include multiple sub-pixels 102. The sub-pixels 102 that make up sub-pixel array 100 can include R, G and B sub-pixels, each color arranged in a channel. The circles can represent valid sensitive areas 104 in the physical structure of each sub-pixel 102, and the gaps 106 between can represent insensitive components such as control gates. In the example of FIG. 1, one pixel 108 includes the three sub-pixels of the same color. Although FIG. 1 illustrates a 3×3 sub-pixel array, in other embodiments the sub-pixel array can be formed from other numbers of sub-pixels, such as a 4×4 sub-pixel array, etc. For the same sub-pixel size, in general the larger the pixel array, the lower the spatial resolution, because each sub-pixel array is bigger and yet ultimately generates only a single color pixel output. Sub-pixel selection can either be pre-determined by design or through software selection for different combinations.

FIGS. 2a, 2b and 2c illustrate exemplary diagonal 3×3 sub-pixel arrays 200, 202 and 204 respectively, each sub-pixel array containing one, two and three clear sub-pixels, respectively, according to embodiments of the invention. To enhance the sensitivity (dynamic range) of the sub-pixel array, one or more of the color sub-pixels can be replaced with clear sub-pixels as shown in FIGS. 2a, 2b and 2c. Note that the placement of the clear sub-pixels in FIGS. 2a, 2b and 2c is merely exemplary, and that the clear sub-pixels can be located elsewhere within the sub-pixel arrays. Furthermore, although FIGS. 1, 2a, 2b and 2c show diagonal orientations, orthogonal sub-pixel orientations can also be employed.

Sub-pixel arrays with more than three clear sub-pixels can also be used, although the color performance of the sub-pixel array can be diminished as a higher percentage of clear sub-pixels are used in the array. With more clear sub-pixels, the dynamic range of the sub-pixel array can go up because more light can be detected, but less color information can be obtained. With fewer clear sub-pixels, the dynamic range will be smaller for a given exposure, but more color information can be obtained. Clear sub-pixels can be more sensitive and can capture more light than color sub-pixels given the same exposure time because they do not have a colorant coating (i.e. no color filter), so they can be useful in dark environments. In other words, for a given amount of light, clear sub-pixels produce a greater response, so they can capture dark scenes better than color sub-pixels. For typical R, G and B sub-pixels, the color filters block most of the light in the other two channels (colors) and only about half of the light in the same color channel can be passed. Thus, a clear sub-pixel can be about six times more sensitive as compared to other colored sub-pixels (i.e. a clear sub-pixel can produce up to six times greater voltage than a colored sub-pixel, given the same amount of light). Thus, a clear sub-pixel captures dark images well, but will get overexposed (saturated) at a smaller exposure time than color sub-pixels given the same layout.

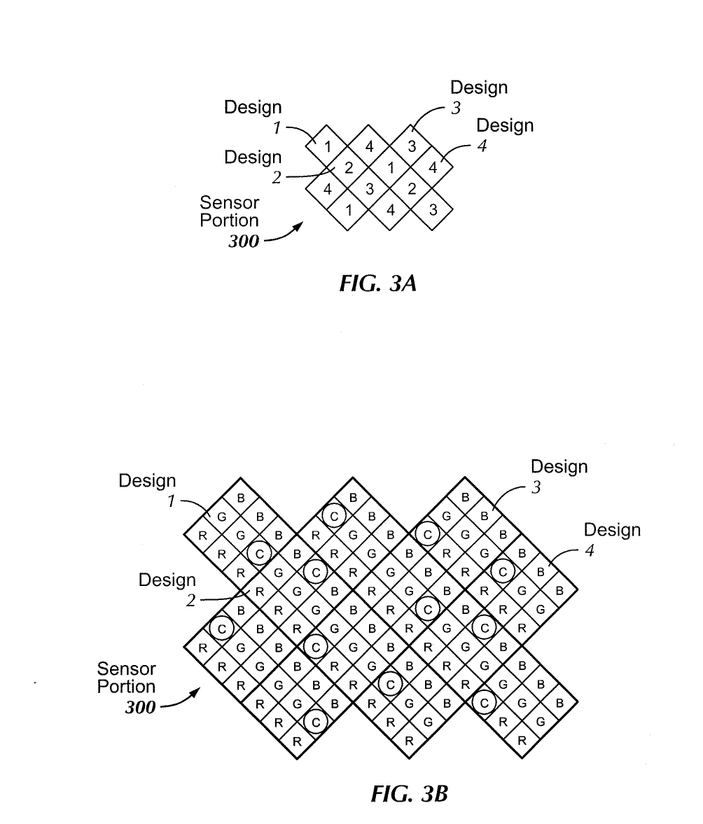

FIG. 3a illustrates an exemplary sensor portion 300 having four repeating sub-pixel array designs designated 1, 2, 3 and 4, each sub-pixel array design having a clear sub-pixel in a different location according to embodiments of the invention.

FIG. 3b illustrates the exemplary sensor portion 300 of FIG. 3a in greater detail, showing the four sub-pixel array designs 1, 2, 3 and 4 as 3×3 sub-pixel arrays of R, G, B sub-pixels and one clear sub-pixel in a different location for every design. Note that the clear sub-pixel is encircled with thicker lines for visual emphasis only. By having several sub-pixel array designs in the sensor, each sub-pixel array design having clear sub-pixels in different locations, a pseudo-random clear sub-pixel distribution in the imager can be achieved, and unintended low frequency Moire patterns caused by pixel regularity can be reduced. After the color pixel outputs are obtained from a sensor having diagonal sub-pixel arrays, such as the one shown in FIG. 3b, further processing can be performed to interpolate the color pixels and generate other color pixel values to satisfy the display requirements of an orthogonal pixel arrangement.

As mentioned above, each sub-pixel array can produce a color pixel output that is a combination of the outputs of the sub-pixels in the sub-pixel array. In some embodiments of the invention, all sub-pixels can have the same exposure time, and all sub-pixel outputs can be normalized to the same range (e.g. between [0,1]). The final color pixel output can be the combination of all sub-pixels (each sub-pixel type having different response curves).

However, in other embodiments, if a higher dynamic range is desired, the exposure time of individual sub-pixels can be varied (e.g. the clear sub-pixel in a sub-pixel array can be exposed for a longer time, while the color sub-pixels can be exposed for a shorter time). In this manner, even darker areas can be captured, while the regular color sub-pixels exposed for a shorter time can capture even brighter areas.

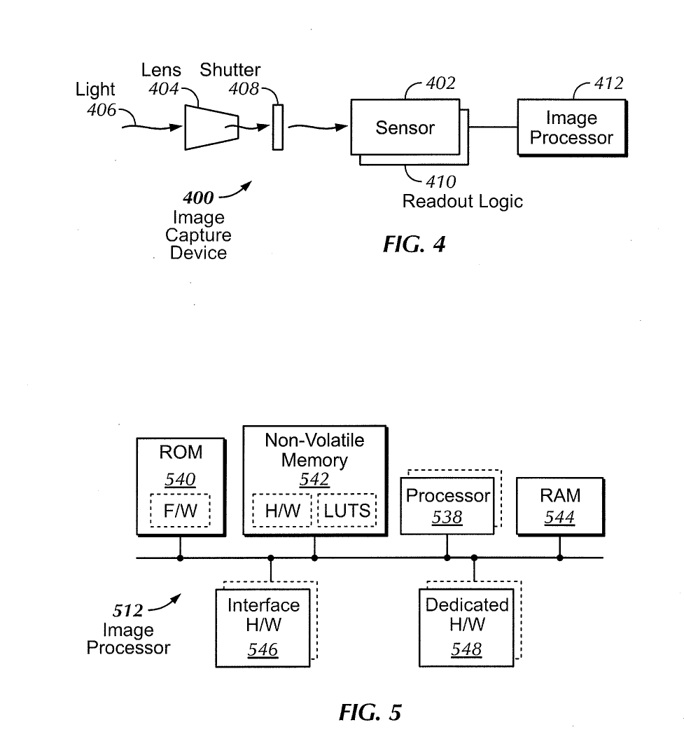

FIG. 4 illustrates an exemplary image capture device 400 including a sensor 402 formed from multiple sub-pixel arrays according to embodiments of the invention. The image capture device 400 can include a lens 404 through which light 406 can pass. An optional shutter 408 can control the exposure of the sensor 402 to the light 406. Readout logic 410, well-understood by those skilled in the art, can be coupled to the sensor 402 for reading out sub-pixel information and storing it within image processor 412. The image processor 412 can contain memory, a processor, and other logic for performing the normalization, combining, interpolation, and sub-pixel exposure control operations described above. The sensor (imager) along with the readout logic and image processor can be formed on a single imager chip. The output of the imager chip can be coupled to a display chip, which can drive a display device.

FIG. 5 illustrates a hardware block diagram of an exemplary image processor 500 that can be used with a sensor (imager) formed from multiple sub-pixel arrays according to embodiments of the invention. In FIG. 5, one or more processors 538 can be coupled to read-only memory 540, non-volatile read/write memory 542, and random-access memory 544, which can store boot code, BIOS, firmware, software, and any tables necessary to perform the processing described above. Optionally, one or more hardware interfaces 546 can be connected to the processor 538 and memory devices to communicate with external devices such as PCs, storage devices and the like. Furthermore, one or more dedicated hardware blocks, engines or state machines 548 can also be connected to the processor 538 and memory devices to perform specific processing operations.

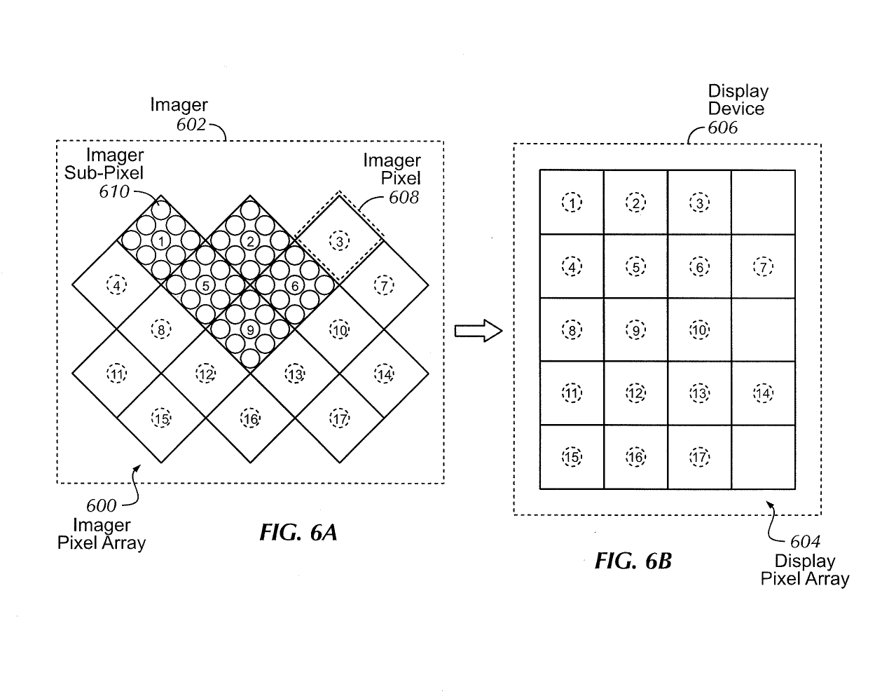

Improving pixel resolution. FIG. 6a illustrates an exemplary color imager pixel array 600 in an exemplary color imager 602. The color imager may be part of an imager chip. The color imager pixel array 600 is comprised of a number of color pixels 608 numbered 1-17, each color pixel comprised of a number of sub-pixels 610 of various colors. (Note that for clarity, only some of the color pixels 608 are shown with sub-pixels 610—the other color pixels are represented symbolically with a dashed circle.) Color images can be captured using the diagonally oriented color imager pixel array 600.

FIG. 6b illustrates an exemplary orthogonal color display pixel array 604 in an exemplary display device 606. Color images can be displayed using the orthogonal color display pixel array 604. Although the 17 color pixels used for image capture are diagonally oriented as shown in FIG. 6a, the color pixels used for display are nevertheless arranged in rows and columns, as shown in FIG. 6b. As a consequence, if the captured color imager pixel data for the 17 diagonally oriented color imager pixels in FIG. 6a is applied to the color display pixels of the orthogonal display of FIG. 6b, because of the differences in location between the pixels captured and displayed in the two orientations, the color display pixels become compressed in the horizontal direction, as can be seen from a comparison of the pixel centers represented by dashed circles in FIG. 6a and FIG. 6b. The resultant displayed image will appear horizontally compressed, such that a circle, for example, will appear as a skinny, upright oval.

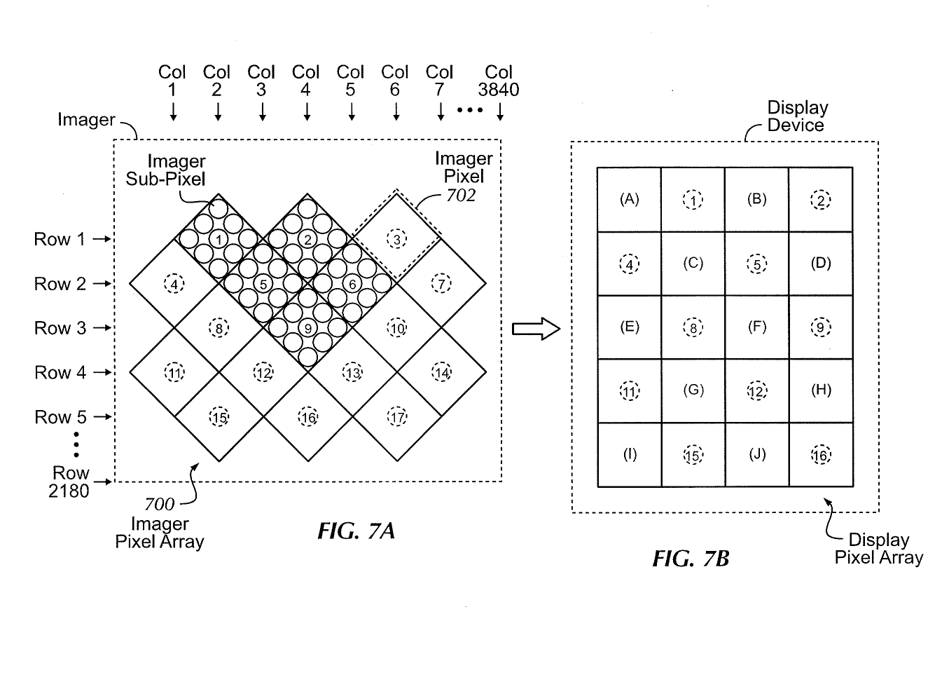

FIG. 7a illustrates an exemplary color imager array for which a first method for compensating for this compression can be applied according to embodiments of the invention. FIG. 7a illustrates a color imager pixel array 700 in an imager chip comprised of 2180 rows and 3840 columns of color pixels 702 arranged in a diagonal orientation. Rather than mapping the captured color imager pixels to adjacent orthogonal display pixels as shown in FIG. 6b, the color imager pixels 702 are mapped to every other orthogonal display pixel in a checkerboard pattern.

FIG. 7b illustrates an exemplary orthogonal display pixel array for which interpolation can be applied in a display chip according to embodiments of the invention. In the example of FIG. 7b, the captured color imager pixels 1, 2, 4, 5, 8, 9, 11, 12, 15 and 16 are mapped to every other orthogonal display pixel. The missing display pixels (identified as (A), (B), (C), (D), (E), (F), (G), (H), (I) and (J)) can be generated by interpolating data from adjacent color pixels. For example, missing display pixel (C) in FIG. 7b can be computed by averaging color information from either display pixels 4 and 5, pixels 1 and 8, or by utilizing the nearest neighbor method (averaging pixels 1, 4, 5, and 8), or utilizing other interpolation techniques. Averaging can be performed either by weighting the surrounding display pixels equally, or by applying weights to the surrounding display pixels based on intensity information (which can be determined by a processor). For example, if display pixel 5 was saturated, it may be given a lower weight (e.g., 20% instead of 25%) because it has less color information Likewise, if display pixel 4 is not saturated, it can be given a higher weight (e.g., 30% instead of 25%) because it has more color information.

Depending on the amount of overexposure or underexposure of the surrounding display pixels, the pixels can be weighted anywhere from 0% to 100%. The weightings can also be based on a desired effect, such as a sharp or soft effect. The use of weighting can be especially effective when one display pixel is saturated and an adjacent pixel is not, suggesting a sharp transition between a bright and dark scene. If the interpolated display pixel simply utilizes the saturated pixel in the interpolation process without weighting, the lack of color information in the saturated pixel may cause the interpolated pixel to appear somewhat saturated (without sufficient color information), and the transition can lose its sharpness. However, if a soft image or other result is desired, the weightings or methodology can be modified accordingly.

In essence, instead of discarding captured imager pixels, embodiments of the invention utilize diagonal striped filters arranged into evenly matched RGB imager sub-pixel arrays and create missing display pixels to fit the display media at hand. Interpolation can produce satisfactory images because the human eye is “pre-wired” for horizontal and vertical orientation, and the human brain works to connect dots to see horizontal and vertical lines. The end result is the generation of high color purity displayed images.

By performing interpolation as described above, the resolution in the horizontal direction can be effectively doubled. For example, a 5760×2180 imager pixel array comprised of about 37.7 million imager sub-pixels, which can form about 12.6 million imager pixels (red, blue and green) or about 4.2 million color imager pixels, can utilize the interpolation techniques described above to effective increase the total to about 8.4 million color display pixels or about 25.1 million display pixels (roughly the amount needed for a “4 k” camera). (The term “4 k” means 4 k samples across the displayed picture for each of R,G,B (12 k pixels wide and at least 1080 pixels high, and represents an industry-wide goal that is now achievable using embodiments of the invention).

Before the pixels in the color imager can be interpolated as described above, the pixels must be read out. Each sub-pixel in a color imager can be read out individually, or two or more sub-pixels can be combined before they are read out, in a process known as “binning.” In the example of FIG. 7a, about 37.7 million sub-pixels or about 12.6 million binned pixels can be read out. Binning can be performed in hardware on the color imager, during digitization on the imager. Alternatively, all raw sub-pixels can be read out, and binning can be performed elsewhere, which may be desirable for special effects, but may be least desirable from a signal-to-noise perspective. Also, as sub-pixel arrays are super-sampled, any single pixel defects can be easily corrected without any noticeable loss of resolution, as there can be many imager sub-pixels for each displayed pixel on a monitor. For example, in the exemplary device of FIG. 7a, there may be three sub-pixels that comprise one blue pixel on the monitor. If one or two of the three blue sub-pixels are defective, the remaining one or two good blue sub-pixels can be used without loss of resolution, as would be the case for sub-sampled Bayer pattern imager arrays.

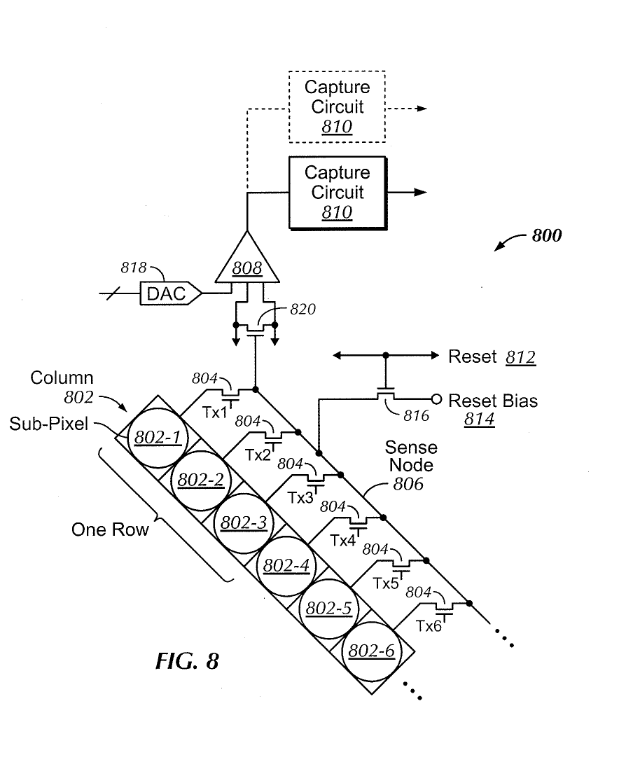

FIG. 8 illustrates an exemplary binning circuit 800 in an imager chip for a single column 802 only showing six sub-pixels of the same color according to embodiments of the invention. It should be understood that there is one binning node 806 for each six sub-pixels in this exemplary digital imager. In the example of FIG. 8, six sub-pixels 802-1 through 802-6 of the same color (e.g., six red sub-pixels) in a single column are laid out in a diagonal orientation, and six different select FETs (or other transistors) 804 couple the sub-pixels 802 to a common sense node 806, which is repeated continuously with one group of six pixels for every two rows. In the example of FIG. 8, there is only one amplifier or comparator circuit 808 located at the end of the repeated pixel structure. The select FETs 804 are controlled by six different transfer lines, Tx1-Tx6. The sense node 806 is coupled to an amplifier or comparator 808, which can drive one or more capture circuits 810. FET 820 is one of the input FETs of a differential amplifier 808 that is located in each grouping of six sub pixels. When the sense node 806 is biased to the pixel background level, FET 820 is turned on, completing the amplifier 808. The shared pixel operation in conjunction with the amplifier is described in U.S. Pat. No. 7,057,150 which is incorporated herein by reference in its entirety for all purposes and is not repeated herein. A reset line 812 can be temporarily asserted to turn on reset switch 816 and apply a reset bias 814 to the sense node 806. As a result of the shared pixels 802-1 through 802-6, any number of the six pixels can be read out at the same time by turning on FETs Tx1 through Tx6 prior to sampling the sense node. Reading out more than one sub-pixel at a time is known as binning.

With continued reference to FIG. 8, the preferred embodiment of sub-pixels 802 utilizes pinned photodiodes and is coupled to the source of a select FET 804, and the drain of the FET is coupled to sense node 806. Pinned photodiodes allow all or most of the photon generated charge captured by the photodiode to be transferred to the sense node 806. One method to form pinned photodiodes is described in U.S. Pat. No. 5,625,210 which is incorporated herein by reference in its entirety for all purposes and is not repeated herein. The drain of the FET 804 can be preset to about 2.5V using the reset bias 814, so when the gate of the FET is turned on by a transfer line Tx, substantially all of the charge that has coupled onto the anode of the PIN photodiode in the sub-pixel 802 can be transferred to the sense node 806. Note that multiple sub-pixels can have their charge coupled onto the sense node 806 in parallel. Because the sense node 806 has a certain capacitance and the voltage on the sense node drops (e.g., from about 2.5V to perhaps 2.1V in one embodiment) when charge is transferred from one or more sub-pixels onto the sense node, the amount of transferred charge can be determined in accordance with the formula Q=CV. When more than one sub-pixel has its charge transferred onto the sense node 806 prior to sampling, it is considered analog binning.

In some embodiments, this post-charge transfer voltage level can be received by device 808 configured as an amplifier, which generates an output representative of the amount of charge transfer. The output of amplifier 808 can then be captured by capture circuit 810. The capture circuit 810 can include an analog-to-digital converter (ADC) that digitizes the output of the amplifier 808. A value representative of the amount of charge transfer can then be determined and stored in a latch, accumulator or other memory element for subsequent readout. Note that in some embodiments, in a subsequent digital binning operation the capture circuit 810 can allow a value representative of the amount of charge transfer from one or more other sub-pixels to be added to the latch or accumulator, thereby enabling more complex digital binning sequences as will be discussed in greater detail below.

In some embodiments, the accumulator can be a counter whose count is representative of the total amount of charge transfer for all of sub-pixels being binned. When a new sub-pixel or group of sub-pixels is coupled to the sense node 806, the counter can begin incrementing its count from its last state. As long as the output of DAC 818 is greater than sense node 806, comparator 808 does not change state, and the counter continues to count. When the output of the DAC 818 lowers to the point where its value exceeds the value on sense node 806 (which is connected to the other input of the comparator), the comparator changes state and stops the DAC and the counter. It should be understood that the DAC 818 can be operated with a ramp in either direction, but in a preferred embodiment the ramp can start out high (2.5V) and then be lowered. As most pixels are near the reset level (or black), this allows for fast background digitization. The value of the counter at the time the DAC is stopped is the value representative of the total charge transfer of the one or more sub-pixels. Although several techniques for storing a value representative of transferred sub-pixel charge have been described, as in U.S. Pat. No. 7,518,646 (incorporated herein by reference in its entirety for all purposes) and those mentioned above for purposes of illustration, other techniques can also be employed according to embodiments of the invention.

In other embodiments, a digital input value to a digital-to-analog converter (DAC) 818 counts up and produces an analog ramp that can be fed into one of the inputs of device 808 configured as a comparator. When the analog ramp exceeds the value on sense node 806, the comparator changes state and freezes the digital input value of the DAC 818 at a value representative of the charge coupled onto sense node 806. Capture circuit 810 can then store the digital input value in a latch, accumulator or other memory element for subsequent readout. In this manner, sub-pixels 802-1 through 802-3 can be digitally binned. After sub-pixels 802-1 through 802-3 have been binned, Tx1-Tx3 can disconnect sub-pixels 802-1 through 802-3, and reset signal 812 can reset sense node 806 to the reset bias 814.

As mentioned above, the select FETs 804 are controlled by six different transfer lines, Tx1-Tx6. When one row of pixel data is being binned in preparation for readout, Tx1-Tx3 can connect sub-pixels 802-1 through 802-3 to sense node 806, while Tx4-Tx6 keep sub-pixels 802-4 through 802-6 disconnected from sense node 806. When the next row of pixel data is ready to be binned in preparation for readout, Tx4-Tx6 can connect sub-pixels 802-4 through 802-6 to sense node 806, while Tx1-Tx3 can keep sub-pixels 802-1 through 802-3 disconnected from sense node 806, and a digital representation of the charge coupled onto the sense node can be captured as described above. In this manner, sub-pixels 802-4 through 802-6 can be binned. The binned pixel data can be stored in capture circuit 810 as described above for subsequent readout. After the charge on sub-pixels 802-4 through 802-6 has been sensed by amplifier 808, Tx1-Tx3 can disconnect sub-pixels 802-4 through 802-6, and reset signal 812 can reset sense node 806 to the reset bias 814.

Although the preceding example described the binning of three sub-pixels prior to the readout of each row, it should be understood that any plurality of sub-pixels can be binned. In addition, although the preceding example described six sub-pixels connected to sense node 806 through select FETs 804, it should be understood that any number of sub-pixels can be connected to the common sense node 806 through select FETs, although only a subset of those sub-pixels may be connected at any one time. Furthermore, it should be understood that the select FETs 804 can be turned on and off in any sequence or in any parallel combination along with FET 816 to effect multiple binning configurations. The FETs in FIG. 8 can be controlled by a processor executing code stored in memory as shown in FIG. 5. Finally, although several binning circuits are described herein for purposes of illustration, other binning circuits can also be employed according to embodiments of the invention.

From the description above, it should be understood how an entire column of same-color sub-pixels can be binned and stored for readout using the same binning circuit, one row at a time. As described, the architecture of FIG. 8 allows a multitude of analog and digital binning combinations that can be performed as the application requires. This process can be repeated in parallel for all other columns and colors, so that binned pixel data for the entire imager array can be captured and read out, one row at a time. Interpolation as discussed above can then be performed within the color imager chip or elsewhere.

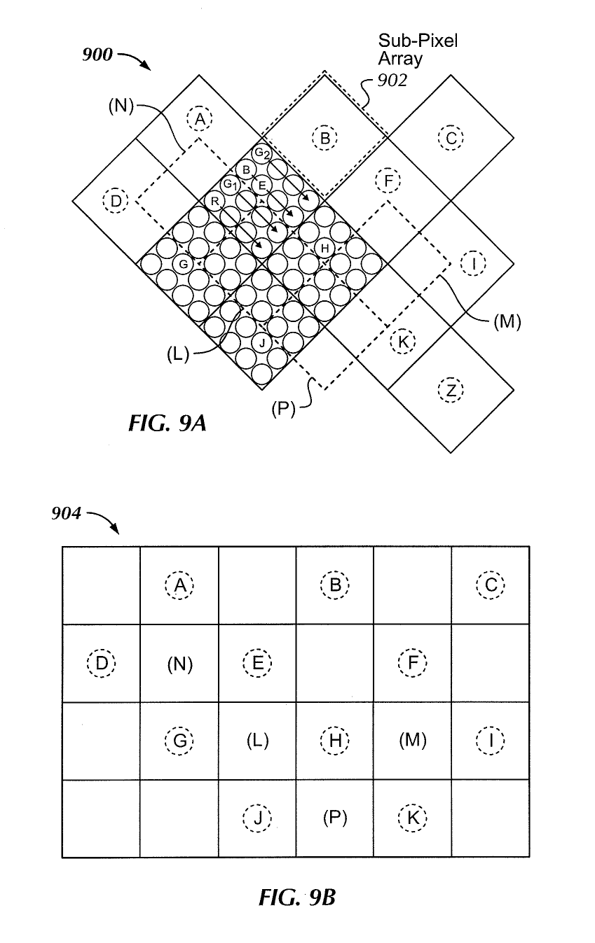

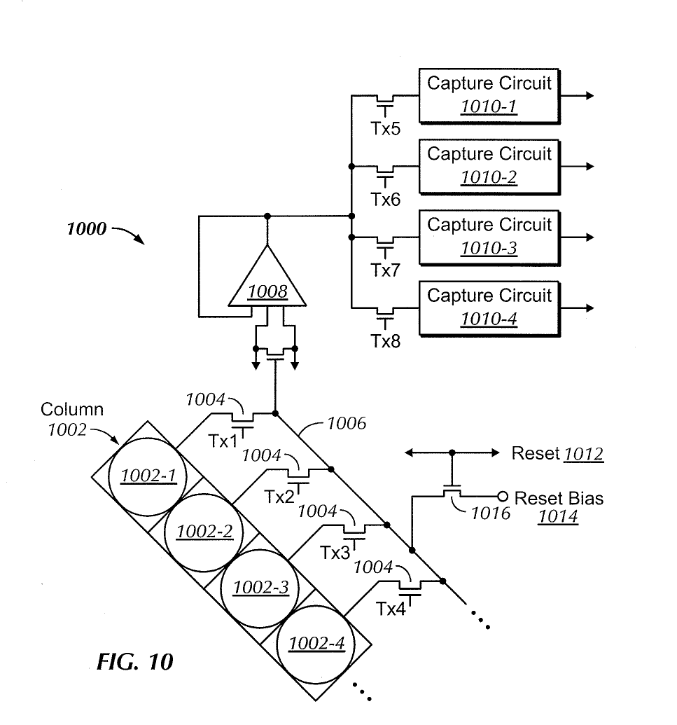

FIG. 9a illustrates an exemplary diagonal color imager 900 and an exemplary second method for compensating for the horizontal compression of display pixels according to embodiments of the invention. In the example of FIG. 9a, color imager 900 includes a number of 4×4 color imager sub-pixel arrays 902 (labeled A through K and Z), although it should be understood that color imager sub-pixel arrays of any size can be used within an imager chip. In the example of FIG. 9a, each 4×4 color imager sub-pixel array 902 includes four red (R) sub-pixels, eight green (four G₁ and four G₂) sub-pixels, and four blue (B) sub-pixels, although it should be understood that other combinations of sub-pixel colors (including different shades of color sub-pixels, complementary colors, or clear sub-pixels) are possible. Each color imager sub-pixel array 1002 constitutes a color pixel.

FIG. 9b illustrates a portion of an exemplary orthogonal display pixel array 902 according to embodiments of the invention. Rather than mapping the captured color imager pixels of FIG. 9a to every other orthogonal display pixel in FIG. 9b and then computing the missing color display pixels by interpolating data from adjacent color display pixels, a display chip according to this embodiment maps the captured color imager pixels to every other orthogonal display pixel and then generates the missing color display pixels by utilizing previously captured sub-pixel data. For example, the missing color display pixel (L) in FIG. 9b can simply be obtained directly from the color imager sub-pixel array (L) in FIG. 9a. In other words, in the context of the orthogonal display pixel array of FIG. 9b, the missing color display pixel array (L) can be obtained directly from the previously captured sub-pixel data from the surrounding color pixel arrays (E), (G), (H) and (J). Note that other missing color display pixels shown in FIGS. 9a and 9b that may be generated in the same manner include pixels (N), (M) and (P).

FIG. 10 illustrates an exemplary readout circuit 1000 in a display chip for a single column 1002 of imager sub-pixels of the same color according to embodiments of the invention. Again, it should be understood that there is one readout circuit 1000 for each column of sub-pixels in a digital imager.

To utilize previously captured sub-pixel data, in one embodiment all sub-pixel information can be stored in off-chip memory when each row of sub-pixels is read out. To read out every sub-pixel, no binning occurs. Instead, when a particular row is to be captured, every sub-pixel 1002-1 through 1002-4 is independently coupled at different times to sense node 1006 utilizing FETs 1004 controlled by transfer lines Tx1-Tx4, and a representation of the charge transfer of each sub-pixel is coupled into capture circuits 1010-1 through 1010-4 using FETs 1016 controlled by transfer lines Tx5-Tx8 for subsequent readout. Although the example of FIG. 10 illustrates four capture circuits 1010-1 through 1010-4 for each column, it should be understood that in other embodiments, fewer capture circuits could also be employed. If fewer that found capture circuits are used, the sub-pixels will have to be captured and read out in series to some extent under the control of transfer lines Tx1-Tx8.

With every imager sub-pixel stored and read out in this manner, the missing color display pixels can be created by an off-chip processor or other circuit using the stored imager sub-pixel data. However, this method requires that a substantial amount of imager sub-pixel data be captured, read out, and stored in off-chip memory for subsequent processing in a short period of time, so speed and memory constraints may be present. If, for example, the product is a low-cost security camera and monitor, it may not be desirable to have any off-chip memory at all for storing imager sub-pixel data—instead, the data is sent directly to the monitor for display. In such products, off-chip creation of missing color display pixels may not be practical.

In other embodiments described below, additional capture circuits can be used in each column to store imager sub-pixel or pixel data to reduce the need for external off-chip memory and/or external processing. Although two alternative embodiments are presented below for purposes of illustration, it should be understood that other similar methods for utilizing previously captured imager sub-pixel data to create missing color display pixels can also be employed.

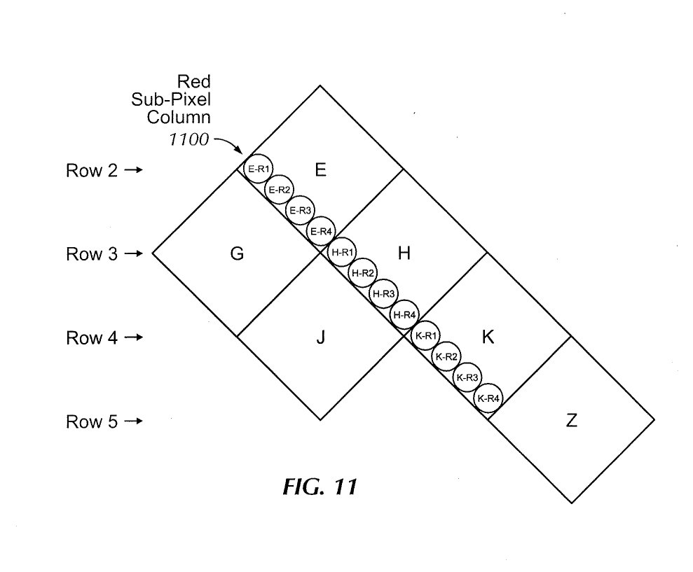

FIG. 11 illustrates a portion of a digital imager presented for explaining embodiments in which additional capture circuits are used in each column according to embodiments of the invention. In FIG. 11, 4×4 sub-pixel arrays E, G, H, J, K and Z are shown, and a column 1100 of red sub-pixels spanning sub-pixel arrays E, H, K and Z is highlighted for purposes of explanation only. The nomenclature of FIG. 11 and other following figures identifies a sub-pixel by its sub-pixel array letter and a pixel identifier. For example, sub-pixel “E-R1” identifies the first red sub-pixel (R1) in sub-pixel array E. Although the examples described below utilize a total of 16 or four capture circuits for each column, it should be understood that other readout circuit configurations having different numbers of capture circuits are also possible and fall within the scope of embodiments of the invention.

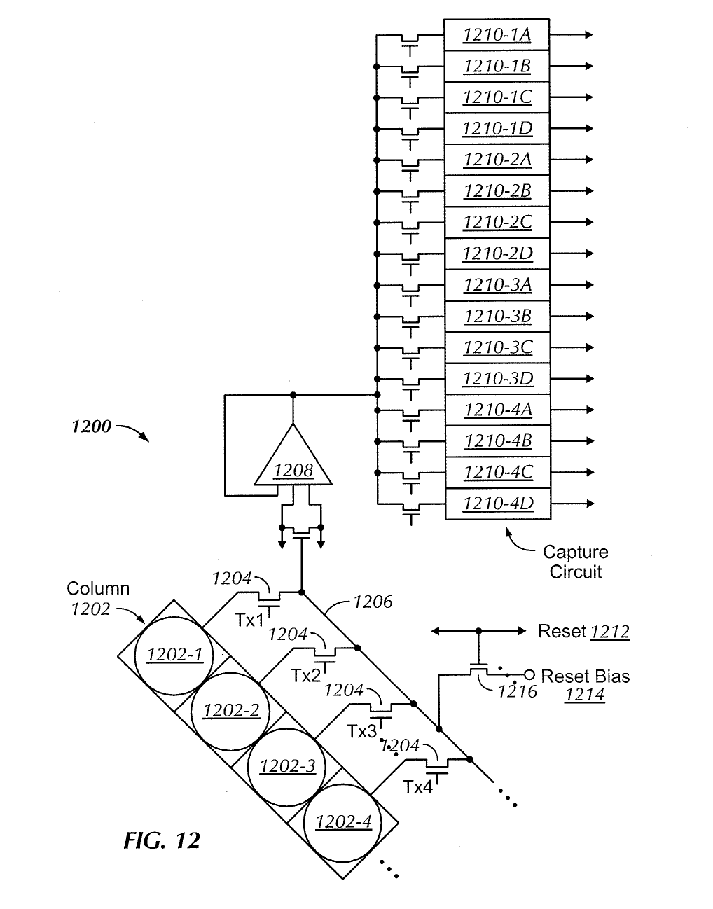

FIG. 12 illustrates an exemplary readout circuit 1200 according to embodiments of the present invention. In the example of FIG. 12, 16 capture circuits 1210 are needed for each readout circuit 1200, four for each sub-pixel.

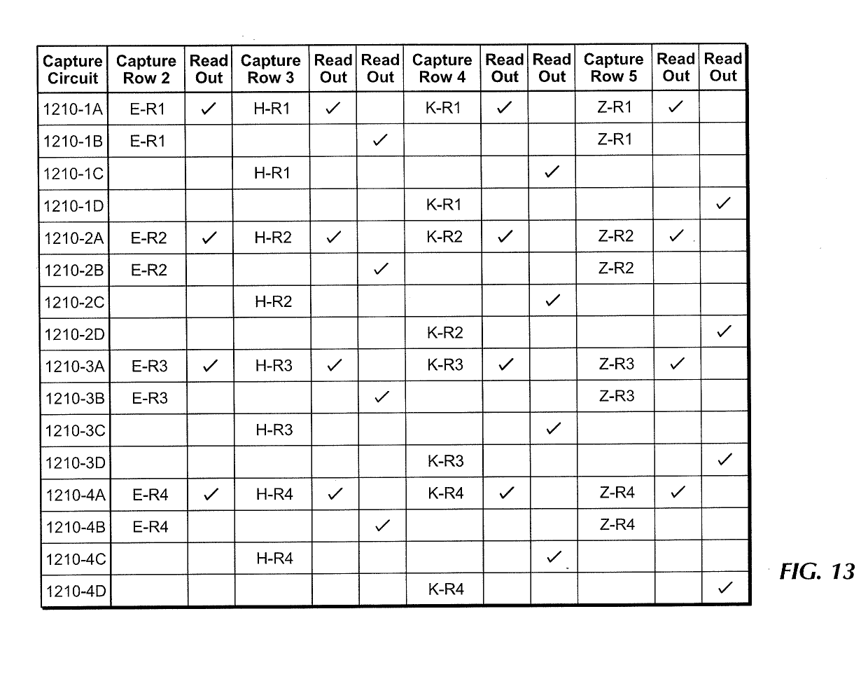

FIG. 13 is a table showing the exemplary capture and readout of imager sub-pixel data for column 1100 of FIG. 11 according to embodiments of the invention. Referring to FIGS. 12 and 13, when row 2 is captured, sub-pixel E-R1 is captured in both capture circuits 1210-1A and 1210-1B, sub-pixel E-R2 is captured in both capture circuits 1210-2A and 1210-2B, sub-pixel E-R3 is captured in both capture circuits 1210-3A and 1210-3B, and sub-pixel E-R4 is captured in both capture circuits 1210-4A and 1210-4B. Next, the sub-pixel data for row 2 (E-R1, E-R2, E-R3 and E-R4), needed for color display pixel (E) (see FIGS. 9a and 9b), can be read out of capture circuits 1210-1A, 1210-2A, 1210-3A and 1210-4A.

When row 3 is captured, sub-pixel H-R1 is captured in both capture circuits 1210-1A and 1210-1C, sub-pixel H-R2 is captured in both capture circuits 1210-2A and 1210-2C, sub-pixel H-R3 is captured in both capture circuits 1210-3A and 1210-3C, and sub-pixel H-R4 is captured in both capture circuits 1210-4A and 1210-4C. Next, the sub-pixel data for row 3 (H-R1, H-R2, H-R3 and H-R4), needed for color display pixel (H) (see FIGS. 9a and 9b), can be read out of capture circuits 1210-1A, 1210-2A, 1210-3A and 1210-4A. In addition, the sub-pixel data for the previous row 2 (E-R1 and E-R2), needed for missing color display pixel (M) (see FIGS. 9a and 9b), can be read out of capture circuits 1210-1B and 1210-2B.

When row 4 is captured, sub-pixel data K-R1 is captured in both capture circuits 1210-1A and 1210-1D, sub-pixel data K-R2 is captured in both capture circuits 1210-2A and 1210-2D, sub-pixel data K-R3 is captured in both capture circuits 1210-3A and 1210-3D, and sub-pixel data K-R4 is captured in both capture circuits 1210-4A and 1210-4D. Next, the sub-pixel data for row 4 (K-R1, K-R2, K-R3 and K-R4), needed for color display pixel (K), can be read out of capture circuits 1210-1A, 1210-2A, 1210-3A and 1210-4A. In addition, the sub-pixel data for the previous row 3 (E-R3, E-R4, H-R1 and H-R2), needed for missing color display pixel (L), can be read out of capture circuits 1210-3B, 1210-4B, 1210-1C and 1210-2C, respectively.

When row 5 is captured, sub-pixel data Z-R1 is captured in both capture circuits 1210-1A and 1210-1D, sub-pixel data Z-R2 is captured in both capture circuits 1210-2A and 1210-2D, sub-pixel data Z-R3 is captured in both capture circuits 1210-3A and 1210-3D, and sub-pixel data Z-R4 is captured in both capture circuits 1210-4A and 1210-4D. Next, the sub-pixel data for row 5 (Z-R1, Z-R2, Z-R3 and Z-R4), needed for color display pixel (Z), can be read out of capture circuits 1210-1A, 1210-2A, 1210-3A and 1210-4A. In addition, the sub-pixel data for the previous row 4 (H-R3, H-R4, K-R1 and K-R2), needed for missing color display pixel (P), can be read out of capture circuits 1210-3C, 1210-4C, 1210-1D and 1210-2D, respectively.

The capture and readout procedure described above with regard to FIGS. 9a, 9b and 11-13 can be repeated for the entire column. Furthermore, it should be understood that the capture and readout procedure described above can be repeated in parallel for each of the columns in the digital imager.

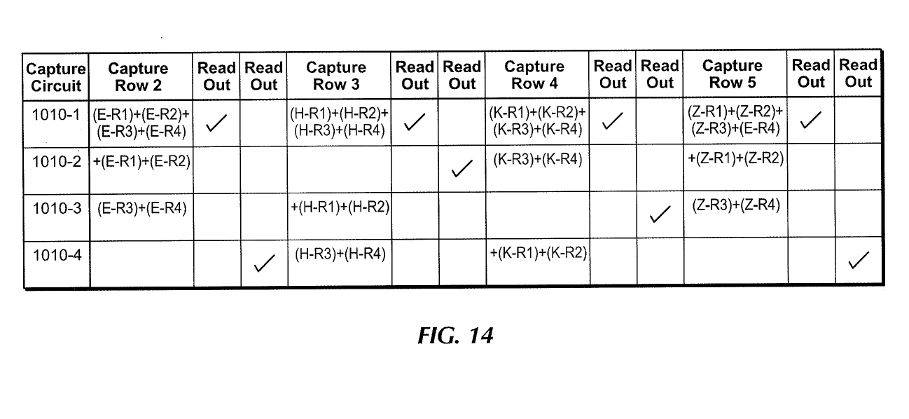

FIG. 14 is a table showing the exemplary capture and readout of binned sub-pixel data for column 1100 of FIG. 11 according to embodiments of the invention. Referring to FIGS. 10 and 14, when row 2 is captured, sub-pixels E-R1, E-R2, E-R3 and E-R4 are binned and captured in capture circuit 1010-1, sub-pixels E-R1 and E-R2 are binned and added to capture circuit 1010-2, and sub-pixels E-R3 and E-R4 are binned and captured in capture circuit 1010-3. Note that to accomplish this, sub-pixels E-R1 and E-R2 can first be binned and stored in capture circuit 1010-1 and added to capture circuit 1010-2, then sub-pixels E-R3 and E-R4 can be binned and stored in capture circuit 1010-3 and added to capture circuit 1010-1 (to complete the binning of E-R1, E-R2, E-R3 and E-R4). Next, the sub-pixel data for row 2 (E-R1, E-R2, E-R3 and E-R4), needed for color display pixel (E), can be read out of capture circuit 1010-1. In addition, the captured sub-pixel data needed to create a missing color display pixel for the previous row 1 can be read out of capture circuit 1010-4.

When row 3 is captured, sub-pixels H-R1, H-R2, H-R3 and H-R4 are binned and captured in capture circuit 1010-1, sub-pixels H-R1 and H-R2 are binned and added to capture circuit 1010-3, and sub-pixels H-R3 and H-R4 are binned and captured in capture circuit 1010-4. Next, the sub-pixel data for row 3 (H-R1, H-R2, H-R3 and H-R 4), needed for color display pixel (H), can be read out of capture circuit 1010-1. In addition, the sub-pixel data for the previous row 2, needed for missing color display pixel (N), can be read out of capture circuit 1010-2.

When row 4 is captured, sub-pixels K-R1, K-R2, K-R3 and K-R4 are binned and captured in capture circuit 1010-1, sub-pixels K-R1 and K-R2 are binned and added to capture circuit 1010-4, and sub-pixels K-R3 and K-R4 are binned and captured in capture circuit 1010-1. Next, the sub-pixel data for row 4 (K-R1, K-R2, K-R3 and K-R4), needed for color display pixel (K), can be read out of capture circuit 1010-1. In addition, the sub-pixel data for the previous row 3 (E-R3, E-R4, H-R1 and H-R2), needed for missing color display pixel (L), can be read out of capture circuit 1010-3.

When row 5 is captured, sub-pixels Z-R1, Z-R2, Z-R3 and Z-R4 are binned and captured in capture circuit 1010-1, sub-pixels Z-R1 and Z-R2 are binned and added to capture circuit 1010-2, and sub-pixels Z-R3 and Z-R4 are binned and captured in capture circuit 1010-3. Next, the sub-pixel data for row 5 (Z-R1, Z-R2, Z-R3 and Z-R4), needed for color display pixel (Z), can be read out of capture circuit 1010-1. In addition, the sub-pixel data for the previous row 4 (H-R3, H-R4, K-R1 and K-R2), needed for missing color display pixel (P), can be read out of capture circuit 1010-4.

The capture and readout procedure described above with regard to FIGS. 9a, 9b, 10, 11 and 14 can be repeated for the entire column. Furthermore, it should be understood that the capture and readout procedure described above can be repeated in parallel for each of the columns in the digital imager. With this embodiment, pixel data can be sent directly to the imager for display purposes without the need to external memory.

The methods described above (interpolation or the use of previously captured sub-pixels) to create missing color display pixels double the display resolution in the horizontal direction. In yet another embodiment, the resolution can be increased in both the horizontal and vertical directions to approach or even match the resolution of the sub-pixel arrays. In other words, a digital color imager having about 37.5 million sub-pixels can utilize previously captured sub-pixels to generate as many as about 37.5 million color display pixels.

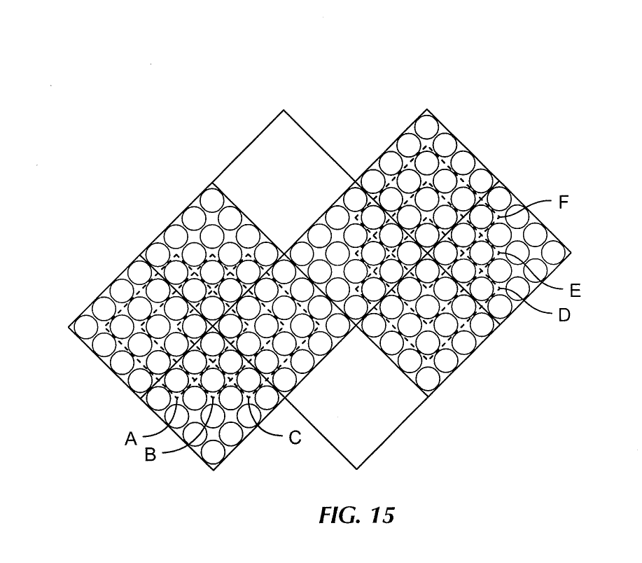

FIG. 15 illustrates an exemplary digital color imager comprised of diagonal 4×4 sub-pixel arrays according to embodiments of the invention. In the example of FIG. 15, instead of creating only one missing color display pixel between any two adjacent color imager pixels, embodiments of the invention create additional missing color display pixels as permitted by the resolution of the color imager sub-pixel arrays. In the example of FIG. 15, a total of three missing color display pixels A, B and C can be generated between each pair of horizontally adjacent color imager pixels using the methodology described above. In addition, a total of three missing color display pixels D, E and F can be generated between each pair of vertically adjacent color imager pixels using the methodology described above. To compute these missing color display pixels, the individual imager sub-pixel data can be stored in external memory as described above so that the computations can be made after the data has been saved to memory.

Although the examples provided above utilize 4×4 color imager sub-pixel arrays for purposes of illustration and explanation, it should be understood that other sub-pixel array sizes (e.g., 3×3) could also be used. In such embodiments, a “zigzag” pattern of previously captured color imager sub-pixels may be needed to create the missing color display pixels. In addition, sub-pixels configured for grayscale image capture and display can be employed instead of color.

It should be understood that the creation of missing color display pixels described above can be implemented at least in part by the imager chip architecture of FIG. 5, including a combination of dedicated hardware, memory (computer readable storage media) storing programs and data, and processors for executing programs stored in the memory. In some embodiments, a display chip and processor external to the imager chip may map diagonal color imager pixel and/or sub-pixel data to orthogonal color display pixels and compute the missing color display pixels.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A method for generating an orthogonal display pixel array from a diagonal imager pixel array, comprising:
capturing imager pixel data from the diagonal imager pixel array;
mapping the captured imager pixel data for each of a plurality of imager pixels in the imager pixel array to every other orthogonal display pixel in the orthogonal display pixel array in a checkerboard pattern; and
generating missing orthogonal display pixels from the captured imager pixel data.

2. The method of claim 1, further comprising generating the missing orthogonal display pixels by interpolating the captured imager pixel data mapped to the orthogonal display pixels adjacent to the missing orthogonal display pixels.

3. The method of claim 2, further comprising generating the missing orthogonal display pixels by averaging information from the captured imager pixel data mapped to two or more orthogonal display pixels adjacent to the missing orthogonal display pixels.

4. The method of claim 3, further comprising generating the missing orthogonal color display pixels by weighting information from the captured imager pixel data mapped to two or more orthogonal display pixels adjacent to the missing orthogonal display pixels.

5. The method of claim 4, wherein the weighting is based on intensity information from the captured imager pixel data mapped to the two or more orthogonal display pixels adjacent to the missing orthogonal display pixels.

6. The method of claim 2, further comprising capturing the imager pixel data by capturing individual sub-pixels in the imager pixels in the diagonal imager pixel array.

7. The method of claim 2, further comprising capturing the imager pixel data by binning a plurality of sub-pixels in the imager pixels in the diagonal imager pixel array.

8. The method of claim 1, wherein the diagonal imager pixel array includes imager pixels having a least one clear sub-pixel.

9. The method of claim 1, further comprising:
capturing the imager pixel data by capturing sub-pixels in the diagonal imager pixel array; and
reading out the captured sub-pixels before generating the missing orthogonal display pixels directly from the captured sub-pixels.

10. The method of claim 9, further comprising generating the missing orthogonal display pixels directly from the captured sub-pixels mapped to the orthogonal display pixels adjacent to the missing orthogonal display pixels.

11. The method of claim 9, further comprising generating the missing orthogonal display pixels directly from captured sub-pixels located between horizontally adjacent diagonal imager pixels.

12. The method of claim 1, further comprising:
capturing the imager pixel data by capturing sub-pixels in the diagonal imager pixel array; and
for each row in the orthogonal display pixel array,
reading out the captured sub-pixel data mapped to every other orthogonal display pixel in that row, and
reading out the captured sub-pixel data mapped to the missing orthogonal display pixels for the previous row.

13. The method of claim 1, further comprising:
capturing the imager pixel data by binning sub-pixels in the diagonal imager pixel array; and
for each row in the orthogonal display pixel array,
reading out the binned sub-pixel data mapped to every other orthogonal display pixel in that row, and
reading out the binned sub-pixel data mapped to the missing orthogonal display pixels for the previous row.

14. An image capture system, comprising:
an imager chip including a diagonal imager pixel array and a readout circuit configured for capturing imager pixel data from the diagonal imager pixel array; and
a display chip configured for
mapping the captured imager pixel data for each of a plurality of imager pixels in the imager pixel array to every other orthogonal display pixel in an orthogonal display pixel array in a checkerboard pattern, and
generating missing orthogonal display pixels from the captured imager pixel data.

15. The image capture system of claim 14, the display chip further configured for generating the missing orthogonal display pixels by interpolating the captured imager pixel data mapped to the orthogonal display pixels adjacent to the missing orthogonal display pixels.

16. The image capture system of claim 15, the display chip further configured for generating the missing orthogonal display pixels by averaging information from the captured imager pixel data mapped to two or more orthogonal display pixels adjacent to the missing orthogonal display pixels.

17. The image capture system of claim 16, the display chip further configured for generating the missing orthogonal color display pixels by weighting information from the captured imager pixel data mapped to two or more orthogonal display pixels adjacent to the missing orthogonal display pixels.

18. The image capture system of claim 17, wherein the weighting is based on intensity information from the captured imager pixel data mapped to the two or more orthogonal display pixels adjacent to the missing orthogonal display pixels.

19. The image capture system of claim 15, the imager chip further configured for capturing the imager pixel data by capturing individual sub-pixels in the imager pixels in the diagonal imager pixel array.

20. The image capture system of claim 15, the imager chip further configured for capturing the imager pixel data by binning a plurality of sub-pixels in the imager pixels in the diagonal imager pixel array.

21. The image capture system of claim 14, wherein the diagonal imager pixel array includes imager pixels having a least one clear sub-pixel.

22. The image capture system of claim 14:
the imager chip further configured for capturing the imager pixel data by capturing sub-pixels in the diagonal imager pixel array and reading out the captured sub-pixels; and
the display chip further configured for generating the missing orthogonal display pixels directly from the captured sub-pixels.

23. The image capture system of claim 22, the display chip further configured for generating the missing orthogonal display pixels directly from the captured sub-pixels mapped to the orthogonal display pixels adjacent to the missing orthogonal display pixels.

24. The image capture system of claim 22, the display circuit further configured for generating the missing orthogonal display pixels directly from captured sub-pixels located between horizontally adjacent diagonal imager pixels.

25. The image capture system of claim 14, the image capture system integrated into an image capture device.

26. An imager chip comprising:
a diagonal imager pixel array; and
a readout circuit configured for capturing imager pixel data by capturing sub-pixels in the diagonal imager pixel array;
wherein for each row in an orthogonal display pixel array, the readout circuit is further configured for
reading out the captured sub-pixel data mapped to every other orthogonal display pixel in that row, and
reading out the captured sub-pixel data mapped to the missing orthogonal display pixels for the previous row.

27. An imager chip comprising:
a diagonal imager pixel array; and
a readout circuit configured for capturing the imager pixel data by binning sub-pixels in the diagonal imager pixel array;
wherein for each row in an orthogonal display pixel array, the readout circuit is further configured for
reading out the binned sub-pixel data mapped to every other orthogonal display pixel in that row, and
reading out the binned sub-pixel data mapped to the missing orthogonal display pixels for the previous row.
